(19) United States
(12) Patent Application Publication
(10) Pub. No.: US 2011/0115263 A1
(43) Pub. Date: May 19, 2011

(54) Motor vehicle comprising a vehicle seat

(76) Inventors: Claudio Bargheer, Holzgerlingen (DE); Karl Pfahler, Stuttgart (DE); Lothar Renner, Nufringen (DE)

(21) Appl. No.: 10/554,930

(22) PCT Filed: Mar. 17, 2004
(86) PCT No.: PCT/EP2004/002737

§ 371 Date: Aug. 20, 2007

(30) Foreign Application Priority Data
Apr. 29, 2003 (DE) 103 19 146.1

(51) Int. Cl. B60N 2/56; B60H 1/00

(52) U.S. Cl. 297/180.13; 454/121

(57) ABSTRACT

A motor vehicle has a roof which can be opened and a vehicle seat which has an associated air supply device with at least one air outflow opening arranged in the upper region of the seat and via which an airstream can be blown onto the head, shoulder and nape areas of the seat occupant when the roof is open. A heater system for the interior of the motor vehicle being provided. In order to use the air supply device in a universal manner, it is used to heat up the interior during a heating phase.

### BACKGROUND OF THE INVENTION

The present invention relates to a motor vehicle having a roof which can be opened and a vehicle seat, and more particularly, to a seat which has an associated air supply device with at least one air outflow opening which is arranged in the upper region of the seat and via which an airstream can be blown onto the head, shoulder and nape areas of the seat occupant when the roof of the motor vehicle is open, and a heater system for the interior of the motor vehicle being provided.

DE 199 49 935 C1 has already disclosed a vehicle seat for an open-top motor vehicle in which an air supply device which has an air outflow opening and is integrated in the seat headrest. A warm airstream can be blown onto the head, shoulder and nape areas of the seat occupant via this air outflow opening when the roof is open in order to minimize the unpleasant draft phenomena which are produced when driving with the roof down. A heater system is also provided in order to heat the interior of the motor vehicle.

### SUMMARY OF THE INVENTION

An object of the present invention is to provide a motor vehicle comprising a vehicle seat of the type mentioned in the introduction whose air supply device can be used in a universal manner.

According to the invention, this object has been achieved by a motor vehicle in which the seat air supply device is used during a heating phase for heating up the interior.

In the motor vehicle according to the present invention, the air supply device of the vehicle seat is also provided for the purpose of heating up the interior of the motor vehicle during a heating phase, in addition to its function for blowing air onto the head, shoulder and nape areas of the seat occupant. Because the air supply device comprises a heating system which can be operated independently of the heater system for the interior of the motor vehicle, the air supply device is configured in such a way that it can provide a sufficiently warm airstream emerging from the air outflow opening even shortly after it is switched on.

Whereas the customary heater system for the interior of the motor vehicle, particularly during cold-starting, can provide warm air, for example for defrosting the windshield, only when the engine is running—and then only with some delay—, the air supply device according to the present invention can supply the interior of the motor vehicle with a warm airstream even after a brief switch-on phase. The air supply device is therefore particularly well suited for use in cold temperatures and for cold-starting in order to even provide a pleasantly warm interior and, for example, a defrosted windshield after a short time. In other words, the air supply device can be used as a type of auxiliary heater.

The air supply device has proven particularly advantageous for defrosting the windshield because the air outflow opening is in the upper region of the seat and therefore at a height which experience has shown to be suitable for supplying a warm airstream to the windshield. In this case, the airstream can be adjusted to a throw range at which the windshield can be defrosted particularly well.

One particularly advantageous position of the air outflow opening can be achieved by the backrest of the seat being moved or, in particular folded, forward in the direction of the windshield from the use position into a ventilation position.

In a further embodiment of the invention, the air supply device can be operated by remote control using a transmitter, as a result of which the driver or the seat occupant can even heat up the interior from outside the motor vehicle some time before the planned starting of said motor vehicle. In this context, it would also be feasible for the air supply device to be controlled by radio remote control which is usually present for opening the vehicle.

The air supply device may also have an associated mechanism for detecting seat occupancy, so that the air supply device which is activated to heat up the interior can then be used to supply air to the head, shoulder and nape areas of the seat occupant again when he or she sits in the seat.

### BRIEF DESCRIPTION OF THE DRAWINGS

FIG. 1 shows a schematic side view of a motor vehicle comprising a folding roof which can be opened, with a vehicle seat having an air supply device according to the present invention being shown in the interior of said motor vehicle;

FIG. 2 is a perspective view of the vehicle seat of FIG. 1, with an air outflow opening of the air supply device being arranged in the headrest of said vehicle seat; and

FIG. 3 is a perspective view of the backrest of the vehicle seat of FIG. 2, with the air supply device being integrated in the backrest.

### DETAILED DESCRIPTION OF THE DRAWINGS

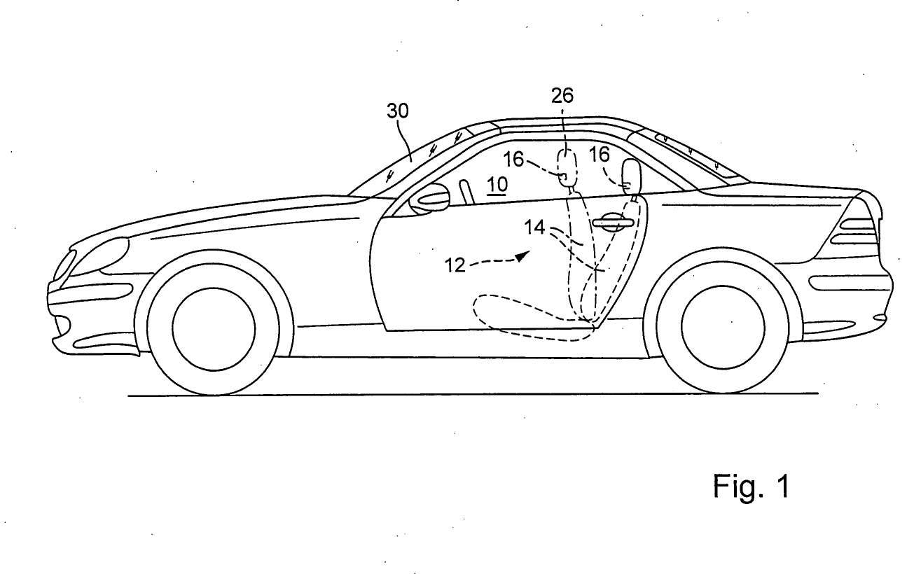

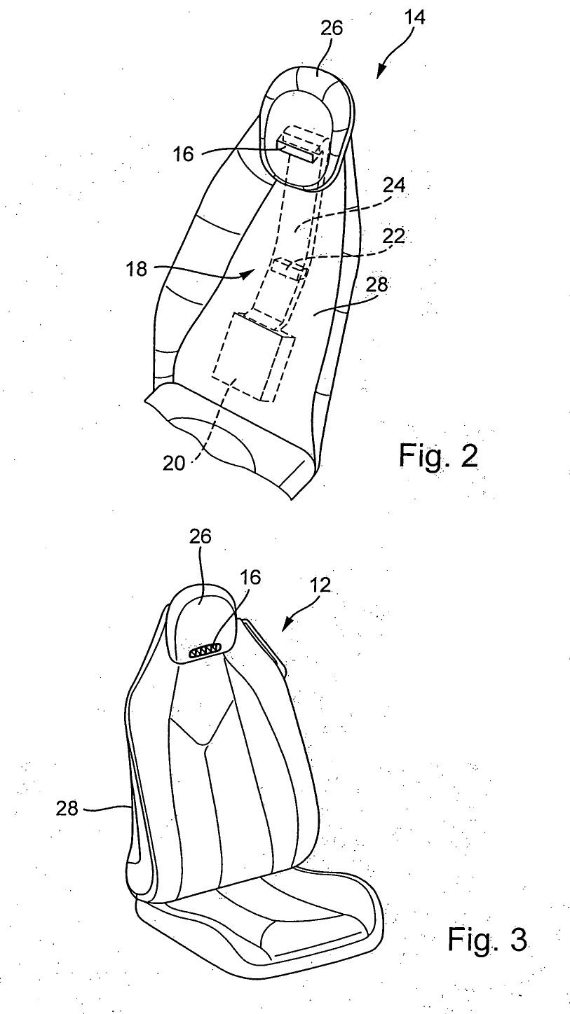

FIG. 1 illustrates a schematic side view of a roadster whose solid folding roof (illustrated in the closed state here) can be opened. A schematically show vehicle seat 12, which is illustrated in perspective view in FIG. 2, can be seen in the interior 10 of the motor vehicle. The vehicle seat 12, which is in the form of an integral seat in this embodiment, has an air outflow opening 16 (see also FIGS. 2 and 3)in the upper region of its backrest 14, via which air outflow opening a warm airstream from an air supply device 18 can be blown onto the head, shoulder and nape areas of the seat occupant. This warm airstream is provided to lessen the unpleasant draft phenomena which are. produced when the motor vehicle is driven with the roof down.

The way in which the air supply device 18 is integrated is apparent from joint consideration with FIG. 3, which is a perspective view of the backrest 14 of the vehicle seat 12. The air supply device 18 essentially comprises a fan 20, an air duct 24 which runs between the fan and the air outflow opening 16, and also a heating element 22, which is arranged within the air duct 24 for heating up the warm airstream emerging from the air outflow opening 16. In the illustrated embodiment, the heating element 22 is in the form of a PTC heating element which heats up immediately after the air supply device 18 is switched on. Besides the air supply device 18, the only parts of the backrest 14 shown in FIG. 3 are a rear trim part 28 and a headrest 26 on whose front face the air outlet opening 16 issues.

In order to quickly heat the interior of the motor vehicle, particularly with cold outside temperatures and when the engine is still cold, the air supply device 18 can be used during a heating phase to quickly heat up the passenger compartment 10. On account of the heating element 22 which heats up even shortly, after the air supply device is switched on, the air supply device 18 is available for heating the interior 10 of the motor vehicle immediately after it is switched on. In this case, the air supply device 18 can be activated in various ways. It is contemplated, for example, for the air supply device 18 to be activated using a conventional transmitter (not illustrated). The transmitter used may be a radio key which is already present in most motor vehicles. It would, of course also be feasible to activate the air supply device 18 with a time switch. In the present embodiment, as illustrated in FIG. 1, the air outflow opening 16 can be moved into a position and, at the same time, the airstream flowing out can be adjusted to a throw range in which the airstream can be used to defrost the windshield 30. To this end, the backrest 14 of the seat 12 is folded forward in the direction of the windshield 30 out of its use position into a ventilation position. In this context, it would, of course, also be feasible to shift the entire vehicle seat 12 forwards in the longitudinal direction.

The heating phase is concluded as soon as the interior 10 has reached the desired temperature following the heating phase and/or the heater system for the interior can provide the temperature desired by the passenger after the engine of the motor vehicle is started. Depending on the desires of the seat occupant, the air supply device 18 can then be used to either heat up the interior of the motor vehicle further or else can be switched off. In this case, the air supply device 18 is preferably controlled by the controller of the air-conditioning system of the motor vehicle. For example, the air supply device 18 can be switched off by the controller of the heater system of the motor vehicle at the end of the heating phase once the temperature desired by the seat occupant is reached.

The air supply device 18 may have an associated known mechanism for detecting seat occupancy (not shown illustrated) which can be used to correspondingly control the air supply device 18 as soon as someone sits in the vehicle seat 12. In other words, the heating phase can be interrupted and the air supply device 18 be switched off, for example, by the mechanism for detecting seat occupancy when the seat is occupied. It is also contemplated for the air supply device 18 to be adjusted to another, preferably lower, temperature and a lesser airstream after the seat occupant gets in.

1-5. (canceled)

6. A motor vehicle, comprising a vehicle seat which has an associated air supply device with at least one air outflow opening arranged in an upper region of the vehicle seat and via which an airstream can be blown onto the head, shoulder and nape areas of a seat occupant when a roof of the motor vehicle is open, and a heater system for the interior of the motor vehicle, wherein the air supply device is used during a heating phase for heating up the interior.

7. The motor vehicle as claimed in claim 6, wherein the air outflow opening is configured to be moveable into a position and the airstream flowing out adjustable to a throw range such that the airstream is able to defrost a windshield.

8. The motor vehicle as claimed in claim 7, wherein a backrest of the seat is configured to be moveable forward toward the windshield from a use position into a ventilation position in which the air outflow opening is positioned to defrost the windshield.

9. The motor vehicle as claimed in claim 6, wherein the air supply device is arranged to be remotely operated via a transmitter to heat up the motor vehicle's interior.

10. The motor vehicle as claimed in claim 6, wherein the air supply device has an associated device to detect seat occupancy.

11. A motor vehicle seat, comprising an associated air supply device with at least one air outflow opening arranged in an upper region of the vehicle seat and via which an airstream can be blown onto the head, shoulder and nape areas of a seat occupant when a roof of the motor vehicle is open, and a heater system for the interior of the motor vehicle wherein the air supply device is used during a heating phase for heating up the motor vehicle's interior.

12. The seat as claimed in claim 11, wherein the air outflow opening is configured to be moveable into a position and the airstream flowing out adjustable to a throw range such that the airstream is able to defrost a windshield.

13. The seat as claimed in claim 12, wherein a backrest of the seat is configured to be moveable forward toward the windshield from a use position into a ventilation position in which the air outflow opening is positioned to defrost the windshield.

14. The seat as claimed in claim 11, wherein the air supply device is arranged to be remotely operated via a transmitter to heat up the motor vehicle's interior.

15. The seat as claimed in claim 11, wherein the air supply device has an associated device to detect seat occupancy.
